(19) United States
(12) Patent Application Publication
(10) Pub. No.: US 2009/0164922 A1
(43) Pub. Date: Jun. 25, 2009

(54) Auto toolbar

(76) Inventors: Ouneheuane Phakousonh, Irvine, CA (US); David Hom, Irvine, CA (US); Kelly Goon, Newport Beach, CA (US)

Correspondence Address: Allan Chan, Suite 700, 225 Broadway, New York, NY, 10007, US

(21) Appl. No.: 12/004,652

(22) Filed: Dec. 20, 2007

(51) Int. Cl. G06F 3/00

(52) U.S. Cl. 715/762

(57) ABSTRACT

An embodiment of the invention provides for one or more customizable buttons, used with a downloadable toolbar for an Internet browser. The system is designed to efficiently organize internet content and accessibility. The current invention is customizable for each particular user's interest. The current invention is a vehicle to create a online community of users with similar interest to network and share their personalize selections and categorizations of similar interest. Additionally, the current invention is capable of tracking and notifying users of updated content on their sites of interest to prevent wasteful browsing.

### BACKGROUND OF THE INVENTION

### Field of the Invention

The present invention is directed to computer interfaces and, more particularly, to a method and system of providing customizable toolbars to efficiently and effectively access the internet.

### SUMMARY OF THE INVENTION

An embodiment of the invention includes providing one or more customizable toolbars, which may be associated with a Internet browser or an act as an independent window. The method can comprise directing an Internet browser user, using a computer, to a button modification medium, receiving modification information from the Internet browser user and loading the modified buttons onto a toolbar on the computer. In certain embodiments, information related to the customizable toolbars is stored at a remote server such that a user may implement and/or modify certain parameters regarding the customizable buttons on a user interface computer, and then have access to the buttons while using any other computer. The current invention aims to be the one central place where users can do everything such as but not limited to search, email, chat, watch videos, view photos, listen to music or podcast.

Toolbar Toolbar aims to be the one central place where users can do everything from search, email, chat, watch videos, view photos, listen to music or podcast, and more. Users can create customized and personalized different toolbars for their specific interests eliminating the need to cram all buttons onto one toolbar.

Users can create Tablets on the toolbar which launches multiple applications in a Tablet Window. This Tablet Window can serve as a startup page, a collection of modules, or information for a particular interest. With the Ajax features it will make it easy for users to organize and personalize their toolbars and tablets.

Users can browse other user's toolbar and tablets in the community and replicate their toolbar and tablet if they find it useful. Users can add on and improve on existing toolbars and tablets making it even more useful and contain more content for everyone in the community. Users can share and improve on toolbar—adding more functions and content for users.

Users can share and improve on tablet—adding more functions and content for users. Users can create specific toolbar that they can use and share only with people they choose.

Toolbar will eventually be a central place where users can do anything online, just from a toolbar. Toolbar will make it easy for users to share and send useful content to other users.

A toolbar community will be built where users can not only network with each other but contribute back to their community by sharing their content—news, photos, videos, bookmarks, feeds, toolbars and tablets which others might find useful and can pass along to their friends. Users can discover new sites from other user's bookmarks. Users can receive instant alerts/deals on their toolbar.

Unlike other social networking sites, where you really can't give to others except maybe a compliment, Toolbar allows users in the community to actually share toolbars and tablets that they personally created. Users would also be able to easily share any of their digital content with other users.

The current invention is created to provide a platform where users, tabbers can easily send each other messages, videos, photos, games, bookmarks of sites they find interesting, and whatever they would like to share. Our toolbar community aims to provide tabbers with a central place that they can share, give and help each other in making their online experience a more productive, efficient, and fulfilling one.

The preferred embodiment, users may also utilize the Toolbar to continuously monitor elements on the web desired by the user. For example, the user may be interested in a certain product online to purchase or just of interest. Parameters of Toolbar can be customized to monitor the particular item at selected stores or in general on the web. Users may set a particular price point or price range to be notified by Toolbar. Users may also desire to monitor availability of an item which has been sold out or not yet released. Notification may include but not limited to text messages, phone call, emails, popup notification or fax.

Other objects and features of the present invention will become apparent from the following detailed description, considered in conjunction with the accompanying drawing figures. It is understood, however, that the drawings are designed solely for the purpose of illustration and not as a definition of the limits of the invention, for which reference should be made to the appended claims.

### BRIEF DESCRIPTION OF THE DRAWING FIGURES

FIG. 1 shows one embodiment illustrating the system environment.

FIG. 2 shows one embodiment of signup and download of the toolbar.

FIG. 3 shows one embodiment of a user interface for browsing and downloading different toolbars.

FIG. 4 shows one embodiment of examples of functions performed browsing and adding tablets.

FIG. 5 shows one embodiment of examples of browsing and searching tabbers.

FIG. 6 shows one embodiment of using toolbar help.

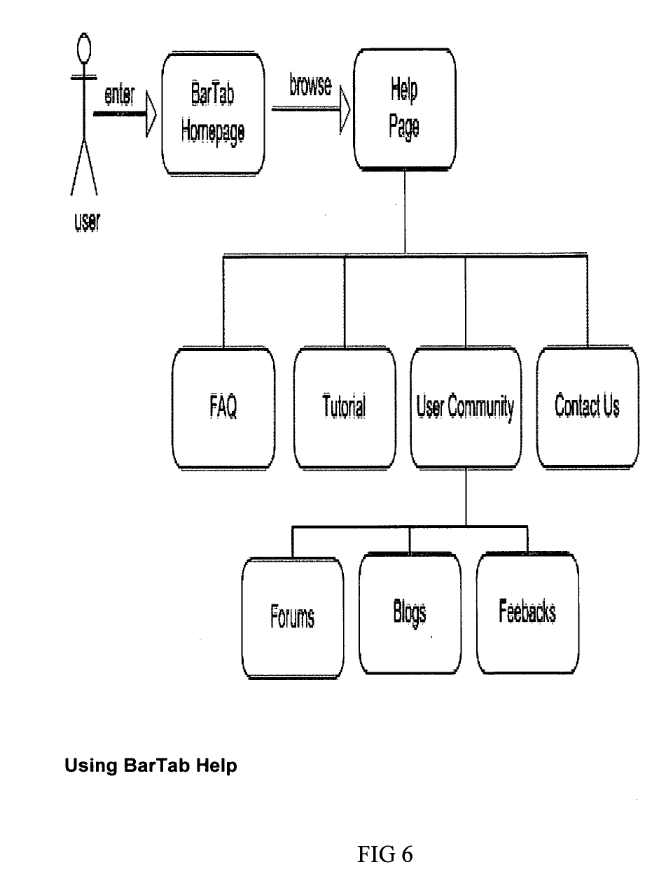

FIG. 7 shows one embodiment of new user download toolbar flowchart.

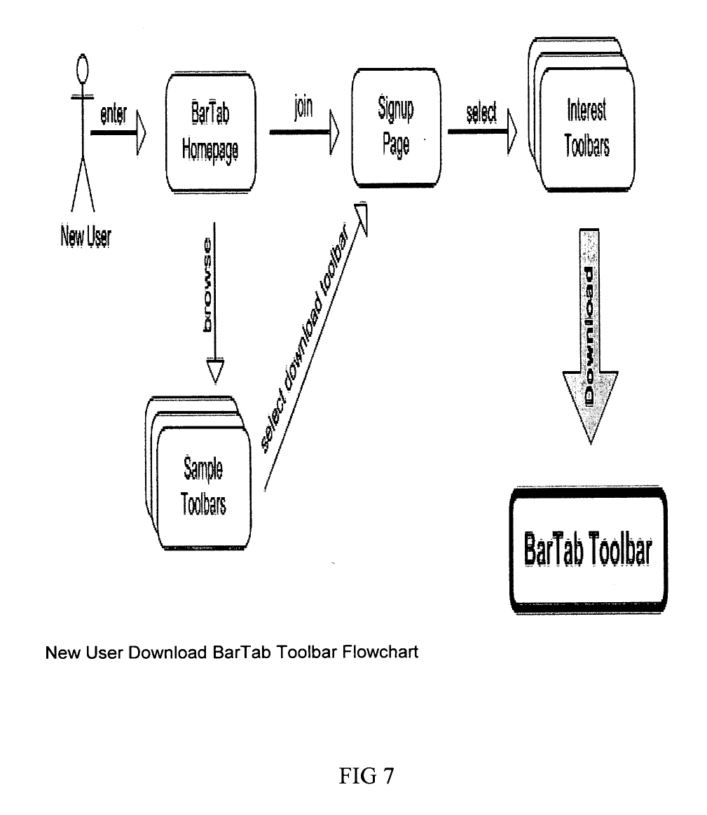

FIG. 8 shows one embodiment of system architecture.

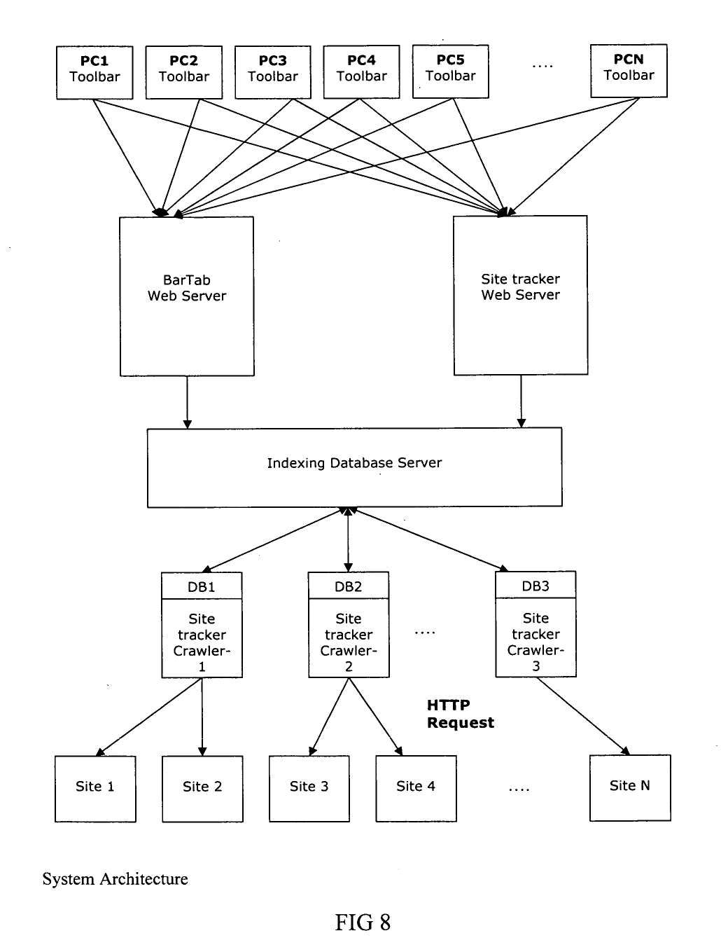

### DETAILED DESCRIPTION OF EXEMPLARY EMBODIMENTS

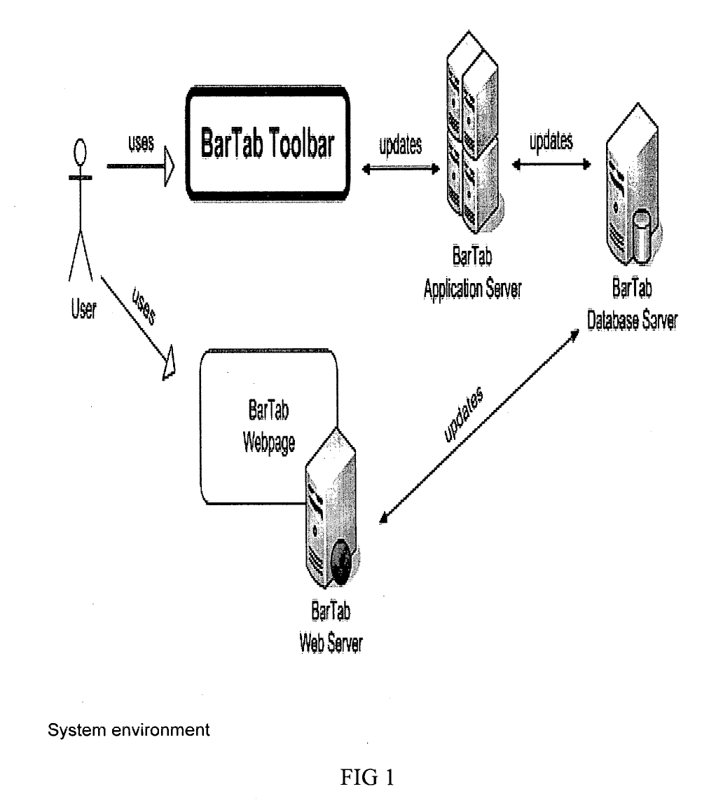

As shown in FIG. 1, a computer is connected to the Internet. Computer includes an internal bus that facilitates communication of information (i.e., digital data) between and among the various devices of the computer and that also facilitates communication between the computer and external devices and systems via a communication interface. A processor coupled to the bus processes information within the computer. The computer also includes a memory such as, for example, Random Access Memory (RAM) and/or other equivalent dynamic memory storage devices, coupled to bus for receiving and storing instructions communicated from the processor. Memory may also be used to temporarily store variable or other intermediate information while the processor executes instructions. Read-Only-Memory (ROM) is also coupled to the bus for storing static data and instructions for use by the processor.

Various input and output devices are provided as part of computer, including, by way of non-limiting example, a display 154 (e.g., cathode ray tube (CRT), liquid crystal display (LCD), etc.), an input device such as a keyboard, and a cursor control device such as a mouse, or trackball, for example. A data storage device such as, for example, a magnetic disk drive and magnetic disk, a CD-ROM drive and CD-ROM, a DVD-ROM drive and DVD-ROM, or other equivalent devices and data storage mediums, is coupled to the bus for communication with the processor, main memory, and communication interface. The storage device preferably has an operating system and an Internet browser software program (i.e., a browser) stored thereon. As will be discussed in greater detail below, a client-side module may also be stored on the data storage device.

The computer may communicatively connect to the Internet via the communication interface over one or more transmission media including, but not limited to, coaxial cable, copper wires, and fiber optical cables. Communication between the computer and the Internet may also be via a wireless or cellular interface. The communication interface facilitates two-way communication between the computer and another electronic device or system, e.g., a server computer or computers provided by a content provider.

An Internet user using the computer may gain access to the Internet by causing the browser to execute, thereby opening a communication link between the communication interface of the computer and an Internet site of content provider, via an Internet Service Provider (ISP). Internet content is communicated by the content provider to the computer for display by browser. Alternatively, a content provider may also be an ISP.

In alternative embodiments, computer may be a desktop or notebook computer, PDA, hand held device, or wireless phone (with graphics capability), or any other device now known or hereafter developed that is capable of performing the functions as described herein.

In accordance with an embodiment of the invention, Toolbar, the content provider for the toolbar, may provide an Internet user with access to a program for controlling the browser. When executed by the user, the controlling program downloads or creates a client-side module such as, for example, a Dynamic Link Library (DLL), on the data storage device of the Internet user's computer. The client-side module preferably includes ActiveX control or Plug-in functionality. Thereafter, when the Internet user accesses the Internet using the browser, the browser opens the client-side module and preferably automatically establishes a connection to the content provider's Internet site. The content provider, in response to the connection established by the browser, loads information and/or functional data into a shell operating within the browser and created by the client-side module. For example, if the user has an account with Toolbar, customized information and/or functionality may be loaded into the client-side module. If the user does not have an account, more generalized (e.g., guest) information and/or functionality may be loaded.

The client-side module essentially opens a shell (or a plurality of shells) within the browser that contains the ActiveX control or Plug-in code that may control, i.e., add, remove, and/or modify, the Internet browser, alternatively the current invention may reside in a stand alone window. When loaded with the ActiveX control or Plug-in, the client-side module preferably contains functions, objects, data, and other software, referred to generally herein as information, that may be used to control the browser. The present invention ensures that the client-side module (and shell) does not close when the Internet user moves, for example, from Internet to another. Thus, the information and/or functionality provided via the ActiveX control or Plug-in is not lost when the Internet user disconnects from the Internet site that loaded the ActiveX control or Plug-in, and connects to another Internet site. In alternate embodiments client-side module may be located at a remote location from the Internet user. The client-side module takes the form of customizable toolbars.

An embodiment of the invention may be provided as a feature of a method of controlling an Internet browser interface displayable by an Internet browser on a display of a computer, and enabling a user of the computer and Internet browser to access and navigate the Internet, receive updated information on targeted websites and to receive and display on the computer display one or more Web pages from one or more Internet sites, including the display of a Web page from a predetermined Internet site, the Internet browser having at least one Internet browser toolbar having at least one toolbar button providing a predetermined functionality to the user of the computer and Internet browser, the method can comprise providing, at the predetermined Internet site, access to a program for controlling the Internet browser interface and making available for downloading by the predetermined Internet site, a file for causing the display of a persistent user toolbar adjacent to said Internet browser toolbar so as to create the visual impression that the user toolbar is an integrated part of the Internet browser, the user toolbar making additional functionality that is not part of the Internet browser prior to download available to the user after download as part of the Internet browser interface, such that once the user toolbar is displayed the user toolbar remains displayed and said additional functionality remains available to the user regardless of a subsequent Internet site to which the Internet browser is caused to navigate after download.

The method of controlling a browser may be implemented using, by way of non-limiting example, a downloadable toolbar. An Internet user may customize the browser so that each time the user accesses the Internet using the browser, user-defined information and/or functionality, e.g., a customizable button on a toolbar, will be displayed with the browser interface. In addition, the toolbar may also include MyBarTab, search, tabbers tablet, add Tablet, bookmark tablet, feeds tablet, photos tablet, videos tablet, podcast tablet, music tablet, email tablet, news tablet, and inbox tablet.

The customizable button acts like a typical toolbar button, except an Internet user can edit the title, the Uniform Resource Identifier (URI), and displayed icon related to the button. When the toolbar is executed, the client-side module can receive some, none or all of the toolbar buttons from Toolbar. The toolbar buttons and their characteristics may be obtained through a feed from Toolbar, the content provider to the client computer.

The request for customizable buttons may be part of a request for the contents of a downloadable toolbar. The request may be an explicit request for customizable button characteristics and/or a content provider may automatically send customizable button characteristics in response to a general request for toolbar content. In an embodiment of the invention, before the request for customizable button characteristics is received by the server, the user at client would sign into or open a new account with the Toolbar. In that embodiment, no customizable button is displayed until the user signs into an account.

Having an account with the content provider and allowing Toolbar to store button characteristics allows multiple users who use the same computer to each have their own button characteristics when using the same computer. Another benefit of certain embodiments is that the same user can use his or her personalized button characteristics at different computers without having to re-set those characteristics at the different computers. Alternatively, if the client does not have an account with the content provider or the client is not signed in, the content provider may transmit standard or generic button characteristics.

In the preferred embodiment, users can create Tablets on the toolbar which launches multiple applications in a Tablet Window. This Tablet Window can serve as a startup page, a collection of modules, or information for a particular interest. With the Ajax features it will make it easy for users to organize and personalize their toolbars and tablets.

Alternatively, users can browse other user's toolbar and tablets in the community and replicate their toolbar and tablet if they find it useful. Users can add on and improve on existing toolbars and tablets making it even more useful and contain more content for everyone in the community. Users can share and improve on toolbar—adding more functions and content for users.

Users may also share and improve on tablet—adding more functions and content for users. Users can create specific toolbar that they can use and share only with people they choose. Ideally Toolbar will eventually be a central place where users can do anything online, just from a toolbar by bypassing useless information on the internet. In an alternate embodiment Toolbar will allow users to share and send useful content to other users.

A toolbar community will exists where users can not only network with each other but contribute back to their community by sharing their content—news, photos, videos, bookmarks, feeds, toolbars and tablets which others might find useful and can pass along to their friends. Users can discover new sites from other user's bookmarks. Users can receive instant alerts/deals on their toolbar.

Toolbar allows users in the community to actually share toolbars and tablets that they personally created. Users would also be able to easily share any of their digital content with other users. One aspect of the current invention to provide a platform where tabbers can easily send each other messages, videos, photos, games, bookmarks of sites they find interesting, and whatever they would like to share. The toolbar community aims to provide tabbers with a central place that they can share, give and help each other in making their online experience a more productive, efficient, and fulfilling one.

Toolbar homepage will allow users to choose and navigate from at least 5 different selections. The first selection is for users to sign up and download our toolbar. Users will come to our website and see the different functionalities and possibilities of our toolbar. Users will be able to see a demo of how they can customize their own toolbar, share their toolbar with others, add other users' toolbars for their own use, and communicate with other users in our toolbar community. Once users decide to sign up for our toolbar, there will be a download button.

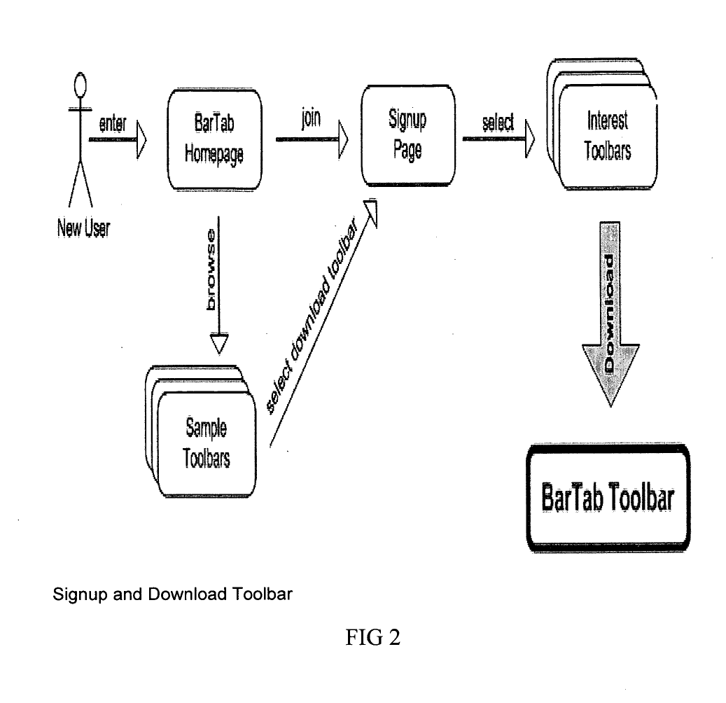

As shown in FIG. 2, the preferred user selection of content for personalized toolbars. There will be at least two methods users will be prompted to our download page. One is when they click the Join Toolbar button from our Homepage. Second is when first time users browse through our website and see a toolbar or tablet they are interested in and click the add Toolbar button. Either method will prompt them to a sign up page which they will be required to fill out their personal info—name, birthday, location, email, and toolbars they are interested in having on their Toolbar. Once user identification process is complete users will be able to download our toolbar. If the users came from clicking the add Toolbar button, then that toolbar or tablet will automatically be added to their Toolbar toolbar when the download process is finished.

Once the download is complete, a screen will appear which introduces said users to their default toolbar, the other toolbars they have selected, and the functions in their toolbar. They will also be shown that they have successfully downloaded their toolbar and only a few short steps from using the most customizable toolbar available on the internet.

In the profile page, users will be shown how they can customize their profile. They can either go through with the demo or skip. Next, users will be prompted to the last step which leads them to a page that shows a demo on how they can start customizing their toolbars. This demo will elaborate a little bit more on tablets (Ref. Tablet page) and the applications and features they can add to their toolbar—allowing them to either skip that page and start using their toolbar. They can either skip this demo or press finish which ends their sign up process.

The other way a user will be prompted to our download page is simply to click on sign up on our homepage. The same steps will apply as above. Once users have downloaded the toolbar and start using it, every tablet that they click on will have a demo on that particular tablet or tab.

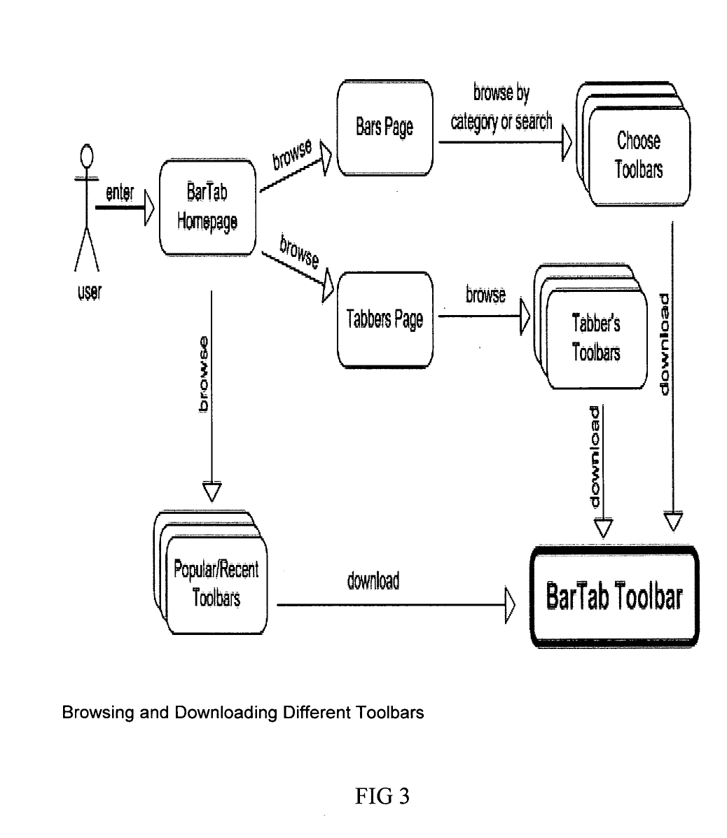

As shown in FIG. 3, the preferred method for users to customize their toolbars. The second selection is for users to search, browse, and add toolbars as well as see other users that have the same toolbar. On BarTabs, bars page, users will be able to search by category, enter a search term in our search area, or search by tags for the toolbar that they might want to add. Ex: if they are into sports, they can browse under sports and see all the different toolbars created for that category. Users will also see a list of the most popular and most recently added toolbars. Users will also see a preview of the different toolbars which contains a title, description, tags, who created the toolbar, when it was last updated, how many times it has been added as well as comments and ratings of the toolbar. The bar page also displays all the tabbers that have a particular toolbar. Ex: If someone searches for a sports toolbar, it will display a list of all the tabbers that own a sports bar. Once users click on the preview for a particular toolbar, it will open another page that gives more details of that specific toolbar.

Once a user arrives at BarTabs toolbars page; they will see a list of most popular toolbars. In the preffered embodiment, users will see a list of toolbars by categories, tags, and most recently added. Once category is selected, the category will collapse into subcategories that list all the toolbars in that subcategory. The page will also display a preview of the toolbar in the main category as well as a preview of the toolbars in the subcategory. Ex. Users click on the main category sports, it will collapse into all subcategories for sports such as basketball, football, baseball, hockey, golf, soccer, tennis, motor racing, cycling and other sports. The page will display a preview of the sports toolbar and all the subcategory toolbars such as basketball, football, baseball, soccer, golf, and so forth. The Toolbar toolbar comprise at least five parts; the options menu, the tablets on the toolbar which are the main features of the toolbar, the tabs on the toolbar which are the other toolbars broken down into tabs, an add bar button, and a search function. The option menu allow for users to adjust any settings on their toolbar and customize the colors of their tablets and toolbars. The option menu also contains a function for sign in/out, an about us, and settings. Tablets are buttons which launch applications such as bookmarks, feeds for photos, videos, news, sports, comics, stocks, and alerts. Tablets can also launch other interactive applications such as calendars, weather, calculator, maps, music players, and many more. The tabs on the toolbar are other toolbars a user has added on their browser. New tabs are created once a user adds any additional toolbar to their browser. The default tab would be called MyBar which is their default toolbar. Once a user clicks on a different tab on their toolbar, the tablets will change accordingly to the new toolbar chosen. The add bar button allows users to add an additional toolbar on their browser. The search function on the toolbar is powered by google and allows users to search anything they want. The results would be the search results from google. There is a drop down menu next to the search box that allows users to choose the type of content they are searching for: image, videos, news, blogs, or local. Here is a list of the different tablets that would be on the default toolbar once a user downloads it. Users then can add the toolbar they want by clicking on the add button icon on the preview of the toolbar. The tabs on the toolbar are other toolbars a user has added on their browser. New tabs are created once a user adds any additional toolbar to their browser. Once a user clicks on a tab the toolbar will update to that tab as well as all the tablets on the toolbar. From there users can use the tablets on the toolbar they have chosen. Users can click a button on their tab which will allow users to share, edit or delete the tab.

Once they click add, the toolbar will be added on their browser. The user also has the option of clicking on the preview of the toolbar for more information. Once they do this, a new page will open where users would be able to see all the details of that toolbar. The page will show the toolbar and all the tablets in that toolbar. On this page there will be two tabs: one will be called Mytab and the other will be called All. Under the Mytab tab, there is a list of all the tablets that were originally created for the toolbar. Then under the All tab, there will be a list of all the tablets for that toolbar that have been added by other users since it was first created. Once they click add, the toolbar will be added on their browser. Then they can choose to add additional tablets that are available for the toolbar they just added. Users will also be able to click on other users on the toolbar page since the site will show the users that have the same toolbars as them and this will lead them to the user's profile page. Through the users profile page, they can see the different toolbars and tablets they have and can add their toolbars and tablets.

The add bar button on the toolbar will direct user's to our toolbar page where users can select from a list of popular toolbars, a list of categories, or search for a specific toolbar they are looking for. Once they have found the toolbar they want, they can easily add it by the click of a button. Then a new tab would be automatically created with the new toolbar they added.

When a user decides to add a toolbar, they can add a toolbar from a list of existing toolbars or they can customize their own toolbar. If a user decides to customize their own toolbar, they will be prompted to add a title, description, and tags for their toolbar. From there, users will be offered a list of suggested tablets that can be added based on the keywords they tagged their toolbar with. If they choose not to add any of the suggested tablets, they can search for other tablets. Another option would be for the user to create personalized tablets which can be added to their toolbar. Once users have finished customizing their new toolbar, they will have the option of sharing it to others or making it for personal use.

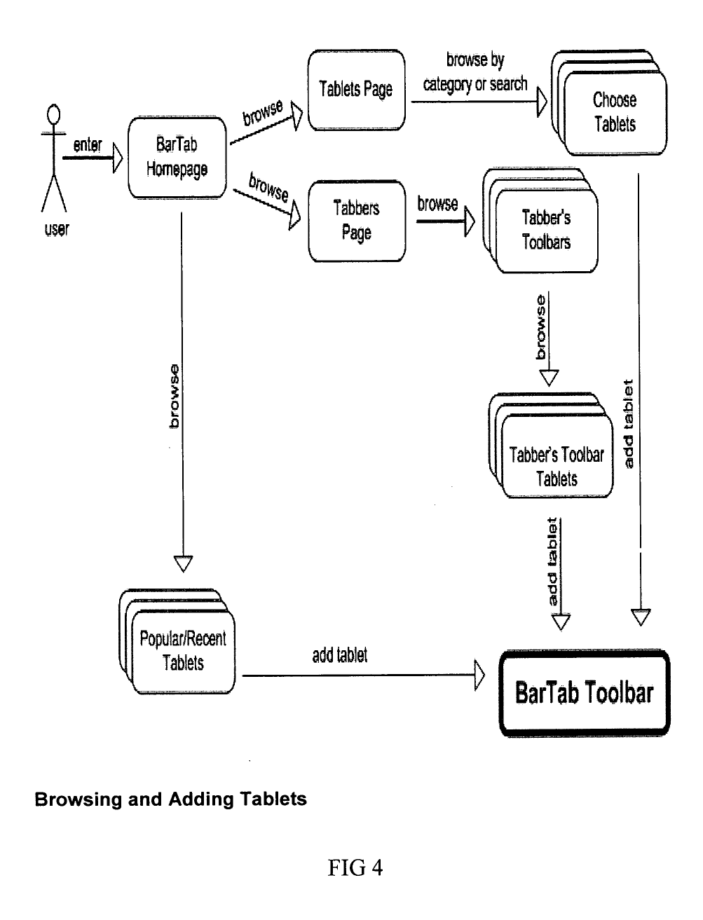

As shown in FIG. 4, the preferred method of customizing tablets. Tablets are buttons which launch applications such as bookmarks, feeds for photos, videos, news, sports, comics, stocks, and alerts to name a few. Tablets can also launch other interactive applications such as calendars, weather, calculator, radio, maps, music players and games. Tablets can include feeds, podcasts, apps, menus and allow users to customize them according to their needs. Once a user clicks any tablet on their toolbar, a new page will drop down. The drop down page would contain all the content or applications a user has in their tablet. Users can also add more content to their tablets from the drop down page. There would also be a settings feature where users can edit the privacy of their tablet allowing only for private use, sharing it with friends only, or sharing it with the toolbar community. In the settings feature, users can also edit or delete tablet, change the title, description, tags, layout, colors and display. The page would also show all the tabbers that have the same tablet, enabling them to interact with each other and potentially share other useful content.

Users may search, browse, and add tablets as well as see other users that have the same tablets. Tablets are buttons which launch applications such as bookmarks, feeds for photos, videos, news, sports, comics, stocks, and alerts.

In an alternative embodiment, tablets can also launch other interactive applications such as calendars, weather, calculator, radio, maps, music players, and many other uses. Tablets can include feeds, modules, and allow users to customize the tablet according to their needs. On our tablets page, users will be able to search by category or tags for the tablet that they might want to add. Ex: If they are interested in sports, they can browse under sports and see all the different tablets created for that category. Users can also see a list of the most popular, most recent, and the most tagged tablets. Users can also see a preview of tablets which contains a title, description, tags, who created the tablet, when it was last updated, how many times it has been added as well as comments and ratings of the tablet. Users would also be able to choose the type of tablet that they are looking for—whether they are feeds, apps, tablets which can contain both feeds and apps in them, or menus which can contain multiple tablets. The tablet page also displays all the tabbers that have a particular tablet. Ex: If someone searches for a sports tablet, it will display a list of all the tabbers that own a sports tablet. Once users click on the preview for a particular tablet, it will open another page that gives more details of that specific tablet. The tablet page will also allow developers and users to create new tablets from our API section.

Once a user arrives at the MyTab tablets page; they will see a list of our most popular tablets. They will also see a list of tablets by categories, tags, and most recently added. Once a user clicks on a category, the category will collapse into subcategories that list all the tablets in that subcategory. The page will also display a preview of the tablet in the main category as well as a preview of the tablets in the subcategory. Ex. Users click on the main category sports, it will collapse into all subcategories for sports such as basketball, football, baseball, hockey, golf, soccer, tennis, motor racing, cycling and other sports. The page will display a preview of all the tablets in that category such as basketball, football, baseball, soccer, golf, and so forth.

Users then can add the tablet they want by clicking on the add button icon on the preview of the tablet. Once they click add, the tablet will be added on their toolbar. The user also has the option of clicking on the preview of the tablet for more information. Once they do this, a new page will open where users would be able to see all the details of that tablet. On this page there will be two tabs: one will be called Mytab and the other will be called All. Under the Mytab tab, there is a list of all the contents that were originally created for the tablet. Then under the All tab, there will be a list of all the different content for that tablet that have been added by other users since it was first created. Once they click add, the tablet will be added to their toolbar. Then they can choose to add additional content for the tablet they just added such as feeds or apps. Users will also be able to click on other users on the tablet page since the site will show the users that have the same tablets as them and this will lead them to the user's profile page. Through the users profile page, they can see the different toolbars and tablets they have and can add their toolbars and tablets.

When a user decides to add a tablet, they can add a tablet from a list of existing tablets or they can customize their own tablet. The existing list of tablets that would be available includes tablet, feeds, apps, or menus. Users can then choose the different types of tablet they would like to add to their toolbar. Ex: if they choose to add a feed tablet, they will only be shown tablets that perform feed functions such as a scores feeds or stats feeds. If they choose an apps tablet, they will be shown a list of apps tablet such as games, maps, currency exchanger, and so forth. If a user decides to create their own tablet, they will be prompted to add a title, description, and tags for their tablet. Then a user must choose the type of tablet they want to create. There choices would be: feed template, apps template which will bring them to our developers API section, or menu template. From there, users will be offered a list of suggested content that can be added based on the keywords they tagged their tablet with. If they choose not to add any of the suggested content, they can search for other content. A person that decides to create a feed tablet would be offered a suggested list of feeds to add to that template. However they can enter their own feed url on our feed tablet template and add as many feeds as they want. Once they're done with the feeds, they can click finish and now have their own customized tablet. Once users have finished customizing their new tablet, they will have the option of sharing it to others or making it only for personal use.

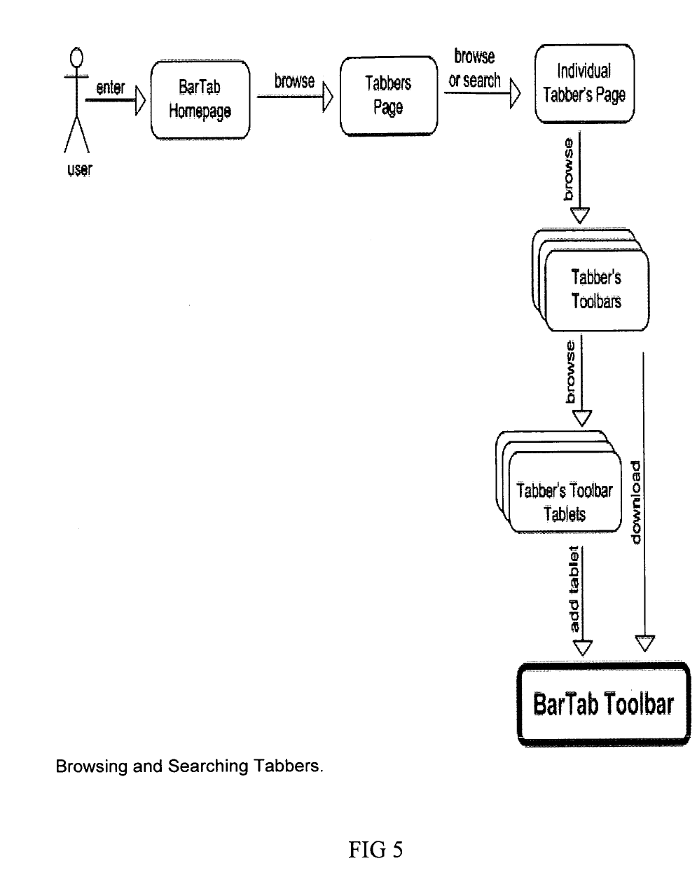

As shown in FIG. 5, the preferred embodiment of the method to customize the tabbers. Tabbers are users who have downloaded our Toolbar toolbar. Each tabber would be assigned their own website and inbox. Each tabber would be able to personalize and customize their toolbar according to their needs. Tabbers will also have a profile that they can customize to their level of content. Tabbers can add photos, videos, bookmarks, blogs, instant messaging, to do lists, bulletin board, games, and many other unique features on their profile. Each tabber has the option of setting different privacy options which can set their toolbars, tablets, and profile to private, allowing no one to see any of their content. They can also set it so that only they're friends have access to their content or they may make it available for all users to see. The same privacy options would be considered when other users are trying to contact each other. We aim to build a toolbar community where tabbers can easily communicate and share with each their content, but also respect each tabber's preference to keep their content private. We aim to be able to provide a platform where tabbers can easily send each other messages, videos, photos, games, bookmarks of sites they find interesting, and whatever they would like to share. We want tabbers to be able to discover, meet, network, connect, learn, help, share, and give to other tabbers within our unique toolbar community.

The tabbers page contains all users and contains a search function that one can search by location, age, gender, interest, or other tabbers that have the same toolbars or tablets. The tabbers page also lists tabbers by most popular, most recent, last login, and most active. The tabbers page also displays a list of popular groups where users can join, add photos, videos, music, blogs, forums, share and discuss matters they have in common.

Once a user arrives at our the tabbers page, they will have the option to search for tabbers based on their preference such as age, gender, location, interest and so forth. The search result will bring about the tabbers within their query. Users can also see a list of the most popular, recently joined, or most active tabbers. Once a user clicks on a tabber they find interesting, they can explore their page and if they find that tabber interesting, they can contact them or request to add them as a friend. Users can also join groups by clicking on the groups they are interested in. Once they click on groups, they will see all the tabbers in that group and what the group is about and join that group.

From Toolbar—User Actor
1. Toolbar Toolbar having a Tablet +AddBar if user clicked on that it will display a Slider window with the options like Add to Videos, Add to Feeds, . . . and Add to Site Tracker, from this option user can add URLs or Some content on the web page to Site Tracker for monitoring.
2. We need to provide some interface to user from where he can manage there Web pages information, given below.
   a. Displaying all Added URLs/Content
      i. It needs to display last Crawled time stamp also
   b. Adding new Web Page URL
   c. Editing existing Web Pages URL
   d. Removing existing URL(s)
   e. Setting Frequency each URL (if user want then only, other wise it is set to Default frequency which is set by Site Tracker Admin), user can set minimum 3 Hr or more frequency.
3. If any change exist in user added Content/URL from toolbar it will display a slider window with in it Highlighting the changed content, if user clicked on the slider window it will display the same page (actual URL) in Browser with changed content highlighting.

From Site Tracker Admin—Admin Actor
1. URL Limit: Every user having there own limit value for adding number of Web pages to site tracker for now it is fixed to 100, for all users initially this value is set to default value which is set from the Site Tracker Admin panel by Site Tracker Admin . . . .
2. Even Site tracker Admin can set the URLs adding limit to particular user(s). Ex:—Like I want to allow my corporate people to 200 URLs/Contents.
3. Crawler Frequency: Site Tracker Admin can set the Crawler(s) Default Crawling frequency value from Control panel by default this value will be applicable for all Crawler . . . .
4. Even Site Tracker Admin can set Frequency value for selected Crawler.
5. Managing Number of Crawlers: Site Tracker Admin can add Crawlers and can set the Crawler details from Admin panel. Like . . . .
   a. Crawler1—visit sites 1 to 1000 with default frequency 1 Day . . . .
   b. Crawler2—visit sites 1001 to 1500 with default frequency 2 Days . . . .
6. And Admin should be able to manage the Crawlers information Adding/removing/modifying frequency.

Architecture:
1. Site Tracker Web Server will be a dedicated server, which will serve all site tracker information to Toolbar, users.
2. Site Tracker Database server will be a dedicated server with high bandwidth capacity, it contain all the information about Site Tracker system.
3. Site Tracker Crawler Server this will be a dedicated server with high bandwidth capacity, it always depend upon the Site Tracker Database for getting frequency, Sites information, . . . and after Crawling Site Tracker Crawler Server will keep information in Site Tracker Database.
4. And the Site Tracker Deployment may contain more than one Site Tracker Crawler Server and it can be added at any time with out disturbing the existing system and those servers can be located in any location.
5. Site Tracker Crawling Logic may improve at any time with out affecting the existing system.
6. Site Tracker Crawling Frequency logic may improve at any time with out effecting existing system.
7. All servers are located at remote places.

While the above invention has been described with reference to certain preferred embodiments, the scope of the present invention is not limited to these embodiments. One skilled in the art may find variations of these preferred embodiments which, nevertheless, fall within the spirit of the present invention, whose scope is defined by the claims set forth below.

We claim:

1. A computer-implemented method for efficiently accessing the internet through an use of an web management of a user interface system on a device, comprising:
a. displaying content on a small screen;
b. user determining when to show and hide the user interface element on the small screen;
c. showing the user interface element when determined, wherein showing the user interface element results in a portion of the content being hidden from view;
d. organizing and inputting all desired websites within said user interface;
e. notifying the user of content updates on user predefined sites; and
f. hiding the user interface when determined.

2. A computer-implemented method for efficiently accessing the internet through an use of an web management of a user interface system on a device, comprising:
a. displaying content on a small screen;
b. user determining when to show and hide the user interface element on the small screen;
c. showing the user interface element when determined, wherein showing the user interface element results in a portion of the content being hidden from view;
d. organizing and inputting all desired websites within said user interface;
e. notifying the user of content updates on user predefined sites;
f. allowing user's an organized access to sites in a predefined user grouping; and
g. hiding the user interface when determined.

3. A computer-implemented method for efficiently accessing the internet through an use of an web management of a user interface system on a device, comprising:
a. displaying content on a small screen;
b. user determining when to show and hide the user interface element on the small screen;
c. showing the user interface element when determined, wherein showing the user interface element results in a portion of the content being hidden from view;
d. organizing and inputting all desired websites within said user interface;
e. notifying the user of content updates on user predefined sites;
f. allowing users to rate selected sites;
g. sharing predefined content rating and personal information with other individuals utilizing system; and
h. and hiding the user interface when determined.

4. The method of claim 1, wherein displaying the user interface as a toolbar.

5. The method of claim 1, wherein displaying the user interface as a toolbar within a web accessing application.

6. The method of claim 1, wherein categorizing all sites with similar themes which maybe based on content and arranged within a tab.

7. The method of claim 1, wherein notifying users of updates to pre-selected websites by said user interface and displaying to the user.

8. The method of claim 1, wherein communicating with other users within said system may be facilitated by the user interface.

9. The method of claim 1, wherein automatically initializing applications based on usage of the user interface.

10. The method of claim 1, wherein displaying updates to pre-selected websites to the user through the user interface without the user visiting said site.

11. The method of claim 1, wherein allowing users to recommend websites to new and current users within the system.

12. The method of claim 1, wherein facilitating communications between other users with like interests through the user interface.

13. The method of claim 1, wherein facilitating social networking of users with like interest through the user interface.

14. The method of claim 1, wherein exchanging data between system users through the user interface.

15. The method of claim 1, wherein facilitating searches through the user interface within the internet to locate additional sites to allocate to the user's personal interface.

16. The method of claim 1, wherein customizing said the appearance and interactivity of the user interface maybe accomplished by the user.

17. The method of claim 1, wherein selecting desired category of sites automatically logs the user into the sites being selected.

18. The method of claim 1, wherein sharing of a users entire personal user interface may be facilitated through the system.

19. The method of claim 1, wherein providing a rating system for all websites selected by users of the system.

20. The method of claim 1, wherein providing a synchronization tool for predefined selections of the user within personal use and professional use of the system.

21. The method of claim 1, wherein providing a personalized user interface for each individual on the same computer interface.

22. The method of claim 1, wherein providing security protection for unauthorized access of a user's user interface.

23. The method of claim 1, wherein providing access and sharing of videos, pictures and music.

24. A computer-implemented method for efficiently accessing the internet through an use of an web management of a user interface system on a device, comprising:
a. displaying content on a small screen;
b. user determining when to show and hide the user interface element on the small screen;
c. showing the user interface element when determined, wherein showing the user interface element results in a portion of the content being hidden from view;
d. organizing and inputting all desired websites within said user interface;
e. notifying the user of content updates on user predefined sites;
f. allowing system to rate selected sites based on the frequency of user selection;
g. sharing predefined content rating and user personal information with other individuals utilizing system; and
h. and hiding the user interface when determined.

25. A computer-implemented method for efficiently accessing the internet through an use of an web management of a user interface system on a device, comprising:
a. Predefining aesthetics of the user interface by the user;
b. Predefining groupings of websites by the user to be organized within tabs;
c. Clicking mouse upon the tab of desired grouping of websites;
d. Displaying representations of said sites to the user; and
e. Displaying notice of updates on said grouping of sites.

26. A method as in claim 25 whereas, displaying to the user profile information for users of similar profiles or website selections.

27. A method as in claim 25 whereas, displaying to the user all other website selections of other users within a common general grouping.

28. A computer-implemented method for efficiently accessing the internet through an use of an web management of a user interface system on a device, comprising:
a. Predefining aesthetics of the user interface by the user;
b. Predefining groupings of websites by the user to be organized within tabs;
c. Clicking mouse upon the tab of desired grouping of websites;
d. Displaying representations of said sites to the user;
e. Displaying notice of updates on said grouping of sites; and
f. Displaying updated content to the user.

29. A method as in claim 26 whereas, displaying to the user profile information for users of similar profiles or website selections.

30. A method as in claim 26 whereas, displaying to the user all other website selections of other users within a common general grouping.

31. A computer-implemented method for efficiently accessing the internet through an use of an web management of a user interface system on a device, comprising:
a. Predefining aesthetics of the user interface by the user;
b. Predefining groupings of websites by the user to be organized within tabs;
c. Clicking mouse upon the tab of desired grouping of websites;
d. Displaying representations of said sites to the user;
e. Displaying notice of updates on said grouping of sites; and
f. Launching simultaneously all websites within the predefined grouping upon user request.

32. A method as in claim 31 whereas, displaying to the user profile information for users of similar profiles or website selections.

33. A method as in claim 31 whereas, displaying to the user all other website selections of other users within a common general grouping.

34. A computer-implemented method for efficiently accessing the internet through an use of an web management of a user interface system on a device, comprising: displaying content on a small screen;
a. user determining when to show and hide the user interface element on the small screen;
b. showing the user interface element when determined, wherein showing the user interface element results in a portion of the content being hidden from view;
c. organizing all desired websites within said user interface;
d. notifying the user of updates to content on user predefined sites;
e. allowing users to rate selected sites;
f. sharing predefined content rating and personal information with other individuals utilizing system;
g. allowing a user to access the internet with more efficiently without the need for extended browsing and
h. and hiding the user interface when determined.

35. A method as in claim 34 whereas, displaying to the user profile information for users of similar profiles or website selections.

36. A method as in claim 34 whereas, displaying to the user all other website selections of other users within a common general grouping.

37. A computer-implemented method for corporate employees to efficiently access the internet through an use of an web management of a user interface system on a device, comprising:
a. displaying content on a small screen;
b. user determining when to show and hide the user interface element on the small screen;
c. showing the user interface element when determined, wherein showing the user interface element results in a portion of the content being hidden from view;
d. organizing and inputting all desired websites within said user interface;
e. notifying the user of content updates on user predefined sites;
f. allowing user's an organized access to sites in a predefined user grouping; and
g. hiding the user interface when determined.

38. A method as in claim 37, whereas a corporation locking predefined sites to be accessed by the employee.

39. A method as in claim 37, whereas a tracking sites to accessed by employees.

40. A method as in claim 37, whereas storing all employee information on the system for access by the employer.

41. A method as in claim 37, whereas storing corporate data on the system for access by the ease of access by users.

42. A method as in claim 37, whereas a user may access their personalized toolbar remotely from any computer by logging onto server.

43. A computer-implemented method for efficiently accessing the internet through an use of an web management of a user interface system on a device, comprising:
a. Predefining aesthetics of the user interface by the user;
b. Predefining groupings of websites by the user to be organized within buttons;
c. Clicking mouse upon the buttons of desired grouping of websites;
d. Displaying representations of said sites to the user; and
e. Displaying notice of updates on said grouping of sites.

44. A computer-implemented method for efficiently accessing the internet through an use of an web management of a user interface system on a device, comprising:
a. Predefining aesthetics of the user interface by the user;
b. Predefining groupings of websites by the user to be organized within categories;
c. Clicking mouse upon the trigger of desired grouping of applications;
d. Displaying representations of said sites to the user; and
e. Displaying notice of updates on said grouping of sites.

45. A computer-implemented method as in claim 1 wherein said user interface system is secured by protocols such as but not limited to passwords, pass-codes, biometrics or security identification devices.

46. A computer-implemented method as in claim 1 wherein said user may identify a desired retail item online at a desired price or price range in which the interface system will monitor the web or particular online web merchants/auctions selected by the user and notify the user once the user desired price is offered.
